(19) United States
(12) Patent Application Publication
(10) Pub. No.: US 2022/0318236 A1
(43) Pub. Date: Oct. 6, 2022

(54) LIBRARY INFORMATION MANAGEMENT SYSTEM

(71) Applicant: LIBRARY SYSTEMS & SERVICES, Rockville, MD (US)

(72) Inventor: Gary SMITH, Rockville, MD (US)

(73) Assignee: LIBRARY SYSTEMS & SERVICES, Rockville, MD (US)

(21) Appl. No.: 17/221,407

(22) Filed: Apr. 2, 2021

(51) Int. Cl. G06F 16/248; G06F 16/26; G06F 16/2457; G06N 20/00; G06Q 50/26

(52) U.S. Cl. CPC G06F 16/248; G06F 16/26; G06F 16/24573; G06N 20/00; G06Q 50/26; G06F 2216/03

(57) ABSTRACT

A computer-implemented system and method for dynamically generating library reports is provided. An application server may acquire and receive a plurality of raw item datasets each associated with a library item from multiple sources; and map each of the plurality of raw item datasets to a set of parameters to generate a mapped item dataset for each library item by identifying a unique identifier for each raw item dataset associated with each library item. and process a plurality of mapped item datasets to output processed item datasets that corresponds to one or more metrics. The application server may dynamically generate one or more library reports by applying a machine learning algorithm on the processed item datasets. The machine learning algorithm is executed to determine a priority of generating each library report based at least on a user request.

### FIELD OF THE DISCLOSURE

The present disclosure relates to library item data analysis, and more specifically to applying a machine learning algorithm to process library item data for generating customized library reports.

### SUMMARY

In accordance with some embodiments of the present disclosure, there is provided a method implemented by a server computing device for dynamically generating library reports. The server computing device includes a processor and a memory which stores computer-executable instructions executed by the processor. The method may include acquiring and receiving a plurality of raw item datasets each associated with a library item from multiple sources; and mapping each of the plurality of raw item datasets to a set of parameters to generate a mapped item dataset for each library item by identifying a unique identifier for each raw item dataset. The method may include processing a plurality of mapped item datasets to output processed item datasets corresponding to one or more metrics; and dynamically generating one or more library reports by applying a machine learning algorithm on the processed item datasets. The machine learning algorithm is executed by the processor to determine a priority of generating each library report based at least on a user request.

Furthermore, in accordance with some embodiments of the present disclosure, there is provided a system including a server computing device in communication with a user computing device via a network. The server computing device includes a processor and a memory storing computer-executable instructions executed by the processor. The processor may acquire and receive a plurality of raw item datasets each associated with a library item from multiple sources; and map each of the plurality of raw item datasets to a set of parameters to generate a mapped item dataset for each library item by identifying a unique identifier for each raw item dataset. The processor may process a plurality of mapped item datasets to output processed item datasets corresponding to one or more metrics; and dynamically generate one or more library reports by applying a machine learning algorithm on the processed item datasets. The machine learning algorithm is executed to determine a priority of generating each library report based at least on a user request.

### BRIEF DESCRIPTION OF THE FIGURES

The foregoing and other aspects of embodiments are described in further detail with reference to the accompanying drawings, in which the same elements in different figures are referred to by common reference numerals. The embodiments are illustrated by way of example and should not be construed to limit the present disclosure.

FIG. 1 illustrates an example computing system for dynamically generating library reports in accordance with the disclosed principles of the present disclosure.

FIG. 2 schematically illustrates a block diagram of an example library information management system for generating library reports in accordance with the disclosed principles.

FIG. 3 is a flowchart illustrating an example process for generating library reports in accordance with some embodiments disclosed herein.

FIG. 4 is a flowchart illustrating an example process for generating and presenting visualized library reports in accordance with some embodiments disclosed herein.

FIG. 5 shows an example GUI of a graph 500 illustrating all collection profile representing system circulation performance in accordance with some embodiments disclosed herein.

FIG. 6A shows an example GUI of a graph 600A illustrating an adult collection profile in a library report in accordance with some embodiments disclosed herein. FIG. 6B shows an example GUI of a graph 600B presenting a library report including a set of Key Performance Indicators (KPIs) for evaluating the circulation performance in accordance with some embodiments disclosed herein. FIGS. 6C-6E show example GUIs illustrating collection analysis in accordance with some embodiments disclosed herein.

FIGS. 7A-7G show example graphical user interfaces (GUIs) related to generate circulation statistics of the library reports in accordance with some embodiments disclosed herein.

FIG. 8A is an example GUI illustrating a graph of circulation trends in a generated report in accordance with some embodiments disclosed herein. FIG. 8B shows an example graph of a partial monthly circulation record in accordance with some embodiments disclosed herein.

FIGS. 9A-9B are example GUIs illustrating graphs of circulation detail in the generated reports in accordance with some embodiments disclosed herein.

FIGS. 10A-10B shows example GUIs illustrating graphs with collection data related to circulation performance in accordance with some embodiments disclosed herein.

FIGS. 11A-11C shows example GUI with graphs by illustrating selected collections by decimal classification in accordance with some embodiments disclosed herein.

FIG. 12 is a block diagram of an example computing device in accordance with some embodiments disclosed herein.

### DETAILED DESCRIPTION

Embodiments of the present disclosure provide innovative techniques for processing library item information to generate customized library reports in response to user requests.

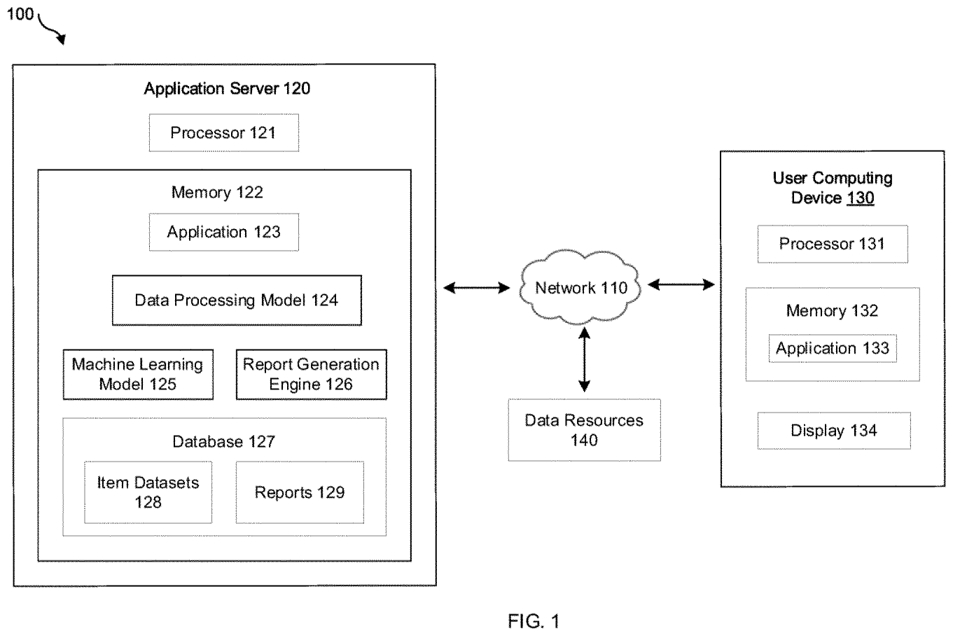

FIG. 1 illustrates an example computing system 100 for dynamically generating library reports in accordance with the disclosed principles. The example computing system 100 may include an application server 120 (e.g., a server computing device 120), a plurality of user computing devices 130 in communication with application server 120, multiple data resources 140 and a network 110. Application server 120 may include a processor 121, a memory 122 and a communication interface for enabling communication over network 110. Network 110 may include the Internet and/or other public or private networks or combinations thereof.

Application server 120 may host a library management platform including a web application, which may be indicative of one or more applications 123 stored in memory 122. The one or more applications 123 are executed by processor 121 for providing library information management services such as generating library reports in response to users' requests. The one or more applications 123 may be executed to continuously receive and update library item data from multiple sources via the network 110. The memory may store a data processing model 124, a machine learning model 125, a report generation engine 126, and other program models, which are implemented in the context of computer-executable instructions executed by the processor 121 of application server 120 for implementing methods, processes, systems and embodiments described in the present disclosure. Generally, the computer-executable instructions may include software programs, objects, models, components, data structures, and the like that are utilized to process specific data and perform one or more methods described herein.

Each user may create a user account with user information for subscribing and accessing to the library information management services through the application 123 for submitting requests to view library item reports related to circulation statistics, collection trend, circulation detail, circulation performance, collection analysis, etc. A user computing device 130 (e.g., a user device 130) may include a processor 131, a memory 132, a browser or mobile application 133 and a display 134. For example, a user device 130 may be a smartphone, personal computer, tablet, laptop computer, mobile device, or other devices. The browser or mobile application 133 may facilitate user interactions with application server 120 to send requests via the application 123 and receive corresponding library item reports through the display 134 via network 110.

Application server 120 and user computing device 130 are each depicted as single devices for ease of illustration, but those of ordinary skill in the art will appreciate that application server 120, and/or user device 130 may be embodied in different forms for different implementations. For example, application server 120 may include a plurality of servers communicating with each other through network 110. Alternatively, the operations performed by application server 120 may be performed on a single server. Application server 120 may be in communication with a plurality of user computing devices 130 to receive data within a cloud-based or hosted environment via a network 110. For example, communication between application server 120 and a user device 130 may be facilitated by one or more application programming interfaces (APIs). APIs of system 100 may be proprietary and/or may be examples available to those of ordinary skill in the art such as Amazon® Web Services (AWS) APIs or the like.

Database 127 may be included in application server 120 or coupled to or in communication with the processor 121 of application server 120 via the network 110. For example, database 127 may include a database management software running on the application server 120. Database 127 may store and update user account information associated with users who subscribe to the library information management services. Database 127 may store and update processed item datasets 128 associated with a plurality of library items via network 110 in real time. Database 127 may store and update library reports 129 generated by processing the item dataset 128 by the processor 121.

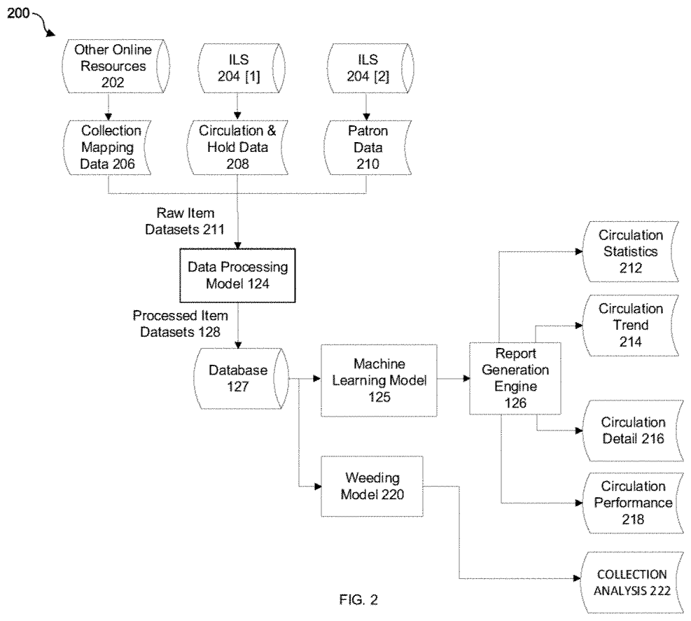

FIG. 2 schematically illustrates a block diagram of an example library information management system 200 in accordance with some embodiments disclosed herein. The library management system 200 may be implemented as computer programs and represent a real-time dashboard operated by the processor 121 of the application server 120 for implementing various functionalities of models, modeling systems, algorithms, processes and embodiments described herein. For example, the system 200 may manage every aspect of the collection for multiple libraries at different locations, such as deciding which titles to acquire for purchasing and cataloging those items, monitoring how they perform once they are in the collection and deciding when to remove them from circulation. The system 200 may include a library management system portal as an interface for users to communicate with various applications of the system 200 through the user computing device 130 via the network 110. The system 200 may include the following applications which can be subscribed to separately or as a whole.

Performance Analytics

The system 200 may combine real-time data from the Integrated Library System (ILS), with data from a variety of other sources including the BISAC bookstore classification, data from other libraries, e.g., the Library of Congress, Above the Treeline, Amazon, the New York Times, Publisher's Weekly, Barnes & Noble and others to provide a detailed view of how the collection is performing.

Acquisitions and Cataloging

The system 200 may be a complete web-based acquisitions and cataloging system that allows libraries to move collection budgeting, fund accounting and purchasing entirely online. The library provides carts or electronic purchase requests lists and orders the titles and receives the invoice of items that have shipped. Collection funds are updated in real-time, so the libraries always knows how much they have spent and the remaining balance. Most items are received fully cataloged and processed, and catalog records may be ordered for any items that are not.

Selection

The system 200 may allow collection development experts to work with the library to set targets and Action Plans for selecting materials for the collection and monitoring collection performance. The corresponding service may be provided on an on-going basis, or for special projects such as opening day collections.

Weeding and Inventory

The system 200 may include a real-time query engine or a weeding model 220 executed by the processor 121 to allow a user to select various criteria to perform collection analysis 222 directly, such as creating weeding lists for the collection and manipulating the lists in real time. The system 200 may provide specialized technology that downloads the weeding lists to handheld scanners which allow users to conduct a complete inventory of the collection and weed it at the same time while the library remains open and at a fraction of the time such projects normally consume. Details about the weeding model 220 will be described below.

As illustrated in FIG. 2, the example system 200 may include a data processing model 124, a machine learning model 125, and a report generation engine 126. The data processing model 124 may receive raw and original data associated with a plurality of electronic library items from multiple resources as inputs.

Application server 120 may import raw library data elements as raw item datasets from multiple resources such as a public or private library system or information institutions. The imported raw library data elements may include:
1) collection, circulation, fund, acquisition, and patron data from external integrated library systems (ILS);
2) MARC (Machine-Readable Cataloging) records;
3) book, video, and other material metadata;
4) demographic, economic and population data from the U.S. Census Bureau;
5) geospatial data and information associated with imported library items; and
6) external data available on library metrics, patron traffic, calendar systems, etc.

Data import may be handled through a direct API or an FTP file transfer. Application server 120 is connected to multiple data sources using an API to import large amounts of raw or original data associated with a plurality of library items. The raw item dataset may be pushed from a data source or may be pulled using a built-in task scheduler. The raw item data may be scheduled and imported at a periodic time such as hourly, daily, weekly. The data importing process does not require a specific data format for each item. The imported data may be aggregated and processed corresponding to specific metrics for generating customized reports based on a specific user request.

For example, application server 120 may be connected to vendor's Integrated library systems (ILS) 204 [1]-[2] via the network 110 to import library item data in a known format. The circulation & hold data 208 and patron data 210 may be directly imported from integrated library systems (ILS) 204 [1]-[2] and already have a format of mapped library item data. Application server 120 may import raw data items from other data resources 202 to obtain collection mapping data 206 including certain mapping collection code, and other data with different formats. The collection mapping data 206, circulation & hold data 208 and patron data 210 may be processed by the data processing model 124 to generate mapped item datasets 129 corresponding to one or more metrics represented as Key Performance Indicators (KPIs) and associated with different collection codes or item categories.

Circulation data of a library item may include “Title”, “Author”, “Publication Date”, “International Standard Book Number (ISBN)”, “Barcode”, “Record Created Date”, “Last Checkout Date”, “Lifetime of checkout”, and “the number of years”, etc. Each item dataset may include an item identifier (ID) associated with a library item. The item ID may be a unique International Standard Book Number (ISBN). The metadata of a library item may include “Publisher”, “Series”, “Title”, “Author”, or a specific MARC record from the Library of Congress, etc. Each item may be assigned to a specific main category and each main category may include a plurality of sub-categories based on types of material and contents.

The mapped datasets may be fed to the machine learning model 125 to generate classified results. The report generation engine 126 may generate one or more library reports in response to user requests based on the classified results.

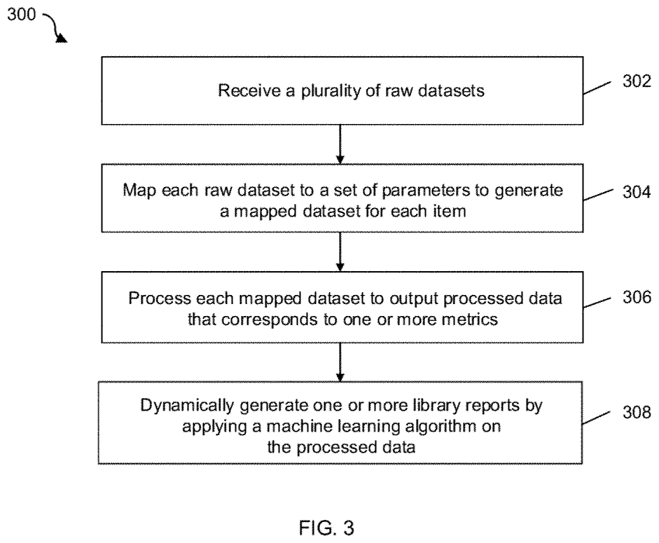

FIG. 3 is a flowchart illustrating an example process or method 300 for processing the imported raw data and generating library reports in accordance with some embodiments disclosed herein. The method 300 may be configured as one or more computer programs executed by the processor 121 of the application server 120 or other computers, in which the library information analytics system, model components, processes, and embodiments described below can be implemented. The order of the operations described herein is not intended to be construed as a limitation, and any number of the described operations can be combined in any order and/or in parallel to implement the method 300.

At 302, application server 120 may receive a plurality of raw item datasets each associated with a library item from integrated library systems (ILS) 204 [1]-[2] and other data resources 202. A plurality of raw item datasets may be indicative as a first set of item datasets. The circulation and hold data 208 and patron data 210 may be directly imported from integrated library systems (ILS) 204 [1]-[2] and already have a specific data format of item datasets. Application server 120 may import raw item datasets 211 associated with a plurality of electronic library items from a variety of other data resources 202 including other libraries, bookstore classifications or publication institutions. Each raw item dataset 211 may be represented in different data formats.

At 304, the data processing model 124 may receive imported raw item datasets 211 as inputs and map each raw dataset 211 to a set of parameters to generate a mapped item dataset for the associated library item based on certain mapping rules. In some embodiments, a data processing model 124 may be executed by the processor 121 to identify a unique item identifier for each raw item dataset 211. Based on the unique item identifier, data processing model 124 may be executed to map the raw item dataset 211 to a set of parameters corresponding to the respective known items to generate the mapped datasets. In the case of a direct mapping, a library item may be identified by a unique ISBN (International Standard Book Number) so that the raw item dataset 211 of the library item may be mapped to metadata on a specific known item or a specific MARC record from the Library of Congress. The item metadata of a specific item may be the set of parameters such as “Publisher”, “Series”, “Title”, “Author”, etc. A census tract may use a government defined census tract ID to map to specific geographic regions also identified by that census tract ID.

In some embodiments, these intermediary mapping tables may be managed within the system through an automated process that identifies the item identifiers ID or other parameters. Based on the unique identifier, each raw item dataset may be mapped to respective metadata of the library item through an intermediary mapping table that links the raw item dataset. A specific collection contained in an ILS may be mapped to these item attributes or parameters using an intermediary mapping table. For example, a budget fund used in an ILS may be mapped through a linking table to a specific collection code or group of collection codes. These intermediary linking tables may be managed within the system or may be created manually. Some integrated library systems may have static relationships between their data elements. For example, a budget fund may be one of those elements. If the relationship between their data elements is static, a table may be created to link the related item IDs in the database. However, if the data was dynamic, the system may generate a user interface to allow an administrator to access an initial mapping table of the system to change the relationship between the data elements as needed.

In some embodiments, the data processing model 124 may be executed by the processor 121 to map one of the set of parameters of the mapped item dataset to a collection code associated with each library item through the intermediary table. The data processing model 124 may further be executed to map the collection code to the set of attributes associated with each respective library item using the intermediary mapping table. The set of parameters may be represented by a set of item attributes including “Age” (e.g., age group), “Classification”, “Material Type”, “Format”, and “Branch Location” in an intermediary table. The collection code may correspond to one of a total number of circulations, a total number of current items, a percentage of total collection, loan period for each collection, a relative usage at a past given period. The specific mapping tables that drive the processor 121 to generate a mapped item dataset may be stored in the database 127.

At 306, the data processing model 124 may be executed by the processor 121 to process a plurality of mapped item datasets to output processed item datasets 128 that corresponds to one or more metrics. The data processing model 124 may be executed to combine and feed the mapped item datasets into normalized data tables or mapping tables that correspond to one or more specific measurable metrics.

A metric may be defined as a relationship to the mapped data associated with the library items. For example, in order to determine the number of items in a collection for a specific material type, a definition of collection code may correspond to an attribute of “Material Type”. Application server 120 may process each individual collection code to material type and calculate the required metric given a selection of time period or other criteria. Application server 120 may allow the creation of any number of metrics and calculate the specific metric as requested based on the selected criteria.

The one or more metrics each may be indicative of a statistics relationship shared by the plurality of the mapped item datasets corresponding to an attribute and a category. Examples of the measurable metric may include circulation metrics, patron metrics, collection metrics, etc.

The circulation metrics may include, but are not limited to:
1) collection circulation by date,
2) percentage of new items that never circulated,
3) percentage of collection uncirculated for 3 years or more,
4) relative use—percentage of circulation/percentage of items,
5) turnover—how fast collection circulates,
6) circulation percentage over time,
7) circulation from location,
8) number of fulfilled holds by date, and
9) percentage of circulation make-up by collection code.

The patron metrics may include, but are not limited to:
1) new patrons registration over time,
2) patron distribution by service area,
3) patron activity level, and
4) patron demographics.

The collection metrics may include, but are not limited to:
1) percentage of collection make-up by collection code
2) collection statistics by collection code during the last year
3) collection statistics by Dewey decimal classification code during the last year
4) collection statistics by BISAC code during the last year
5) total number of items, and
6) new items added to the collection over the previous 24 months.

The processed item datasets 128 may be stored into the database 127 and be used to generate specific library reports. The processed item datasets 128 may be used by the report generation engine 126 to manage user or customer related settings and configurations.

At 308, the processor 121 may execute the machine learning model 125 to apply a machine learning algorithm on the processed data to dynamically generate one or more library reports. In some embodiments, the machine learning model 125 may be executed to apply a random forest classifier to identify what reports to dynamically generate for an individual library or a user of the platform. Past usage patterns and item metadata on each previously visited report may be collected to include a user role, library size, time of day, reports run in same session, previous and subsequent report requests, etc. In addition, frequency of report, and various parameters of previous runs (category, age, collection, branch, etc.) may also collected and added to the decision tree. In some embodiments, past usage patterns may include the collection of user, user role, library size, time of day, reports run in same session, previous and subsequent report requests, etc. Each “visit” from a user may be a collection of data points which include date/time and those data inputs to form the collection. The collection may be used by the machine learning model 125 to predict future reports, and what parameters may be used for a next future report prediction. These reports may then be pre-run to provide immediate cached data.

The report generation process may be activated whenever new data is received by application server 120. The report generation process may pre-process the reports to provide the users a quick real-time access to the reports. If a report is not available when requested, the application server 120 may dynamically generate the report in real-time and add it to a library of available reports which are stored in the database 127. The report generation process utilizes the machine learning algorithm to determine reports that are most likely to be run by a user, and pre-processes those reports to provide fast real-time access to their reports. If a report is not available when requested, a definition of that report may be created and the corresponding meta data is collected and stored with the definition and added to the decision tree. The report may be dynamically generated in real time and added to a library of available reports stored in the database 127. When a user request is made for an existing report, the metadata on that request is updated in the decision tree.

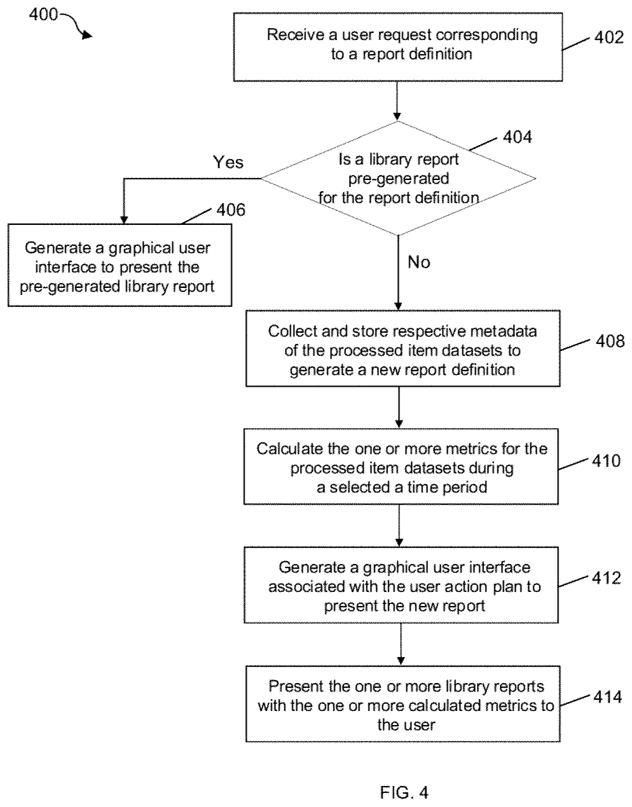

FIG. 4 is a flowchart illustrating an example process 400 for generating and presenting visualized library reports in accordance with some embodiments disclosed herein. The process 400 may be configured as one or more computer programs executed by the processor 121 of the application server 120 or other computers, in which the library information analytics system, model components, processes, and embodiments described below can be implemented.

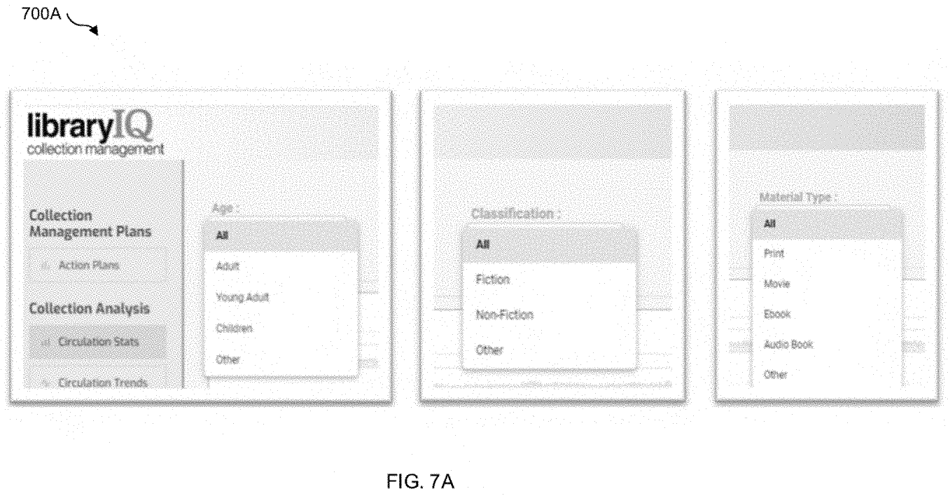

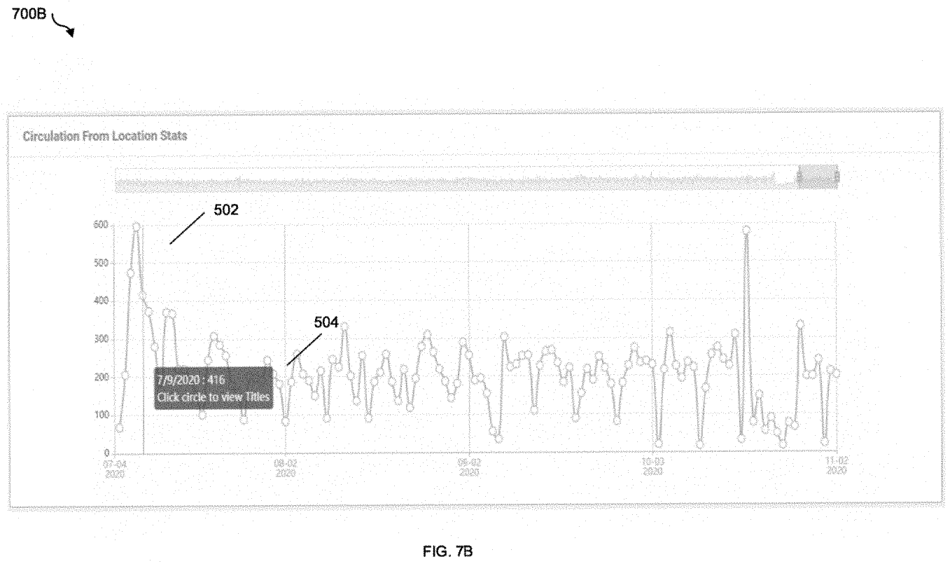

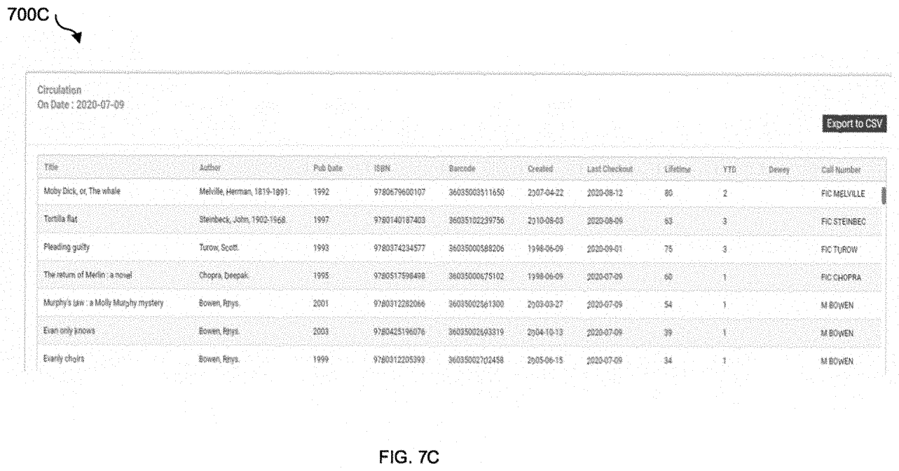

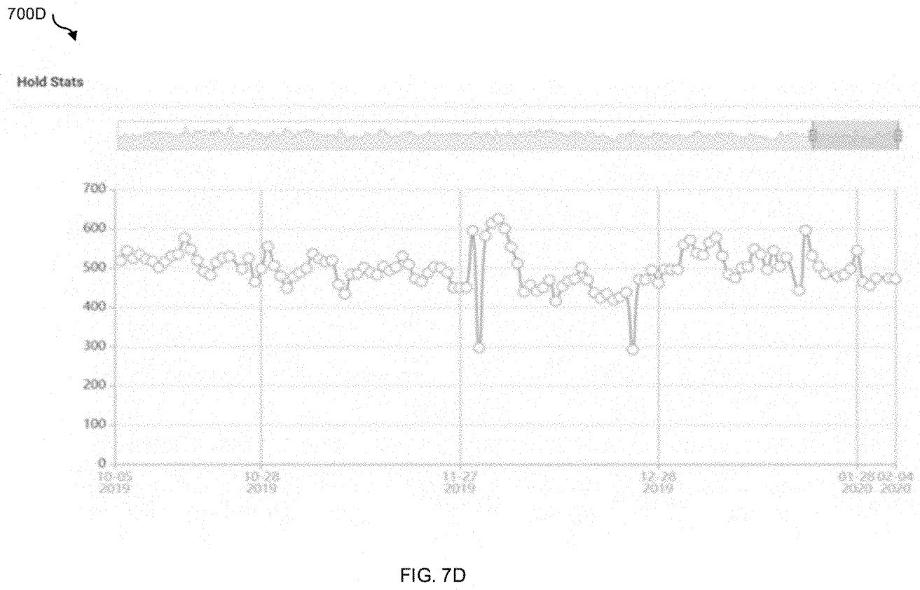

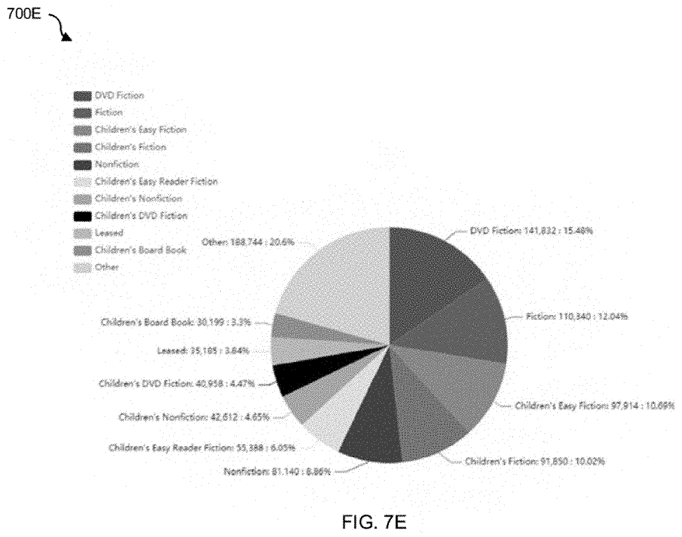

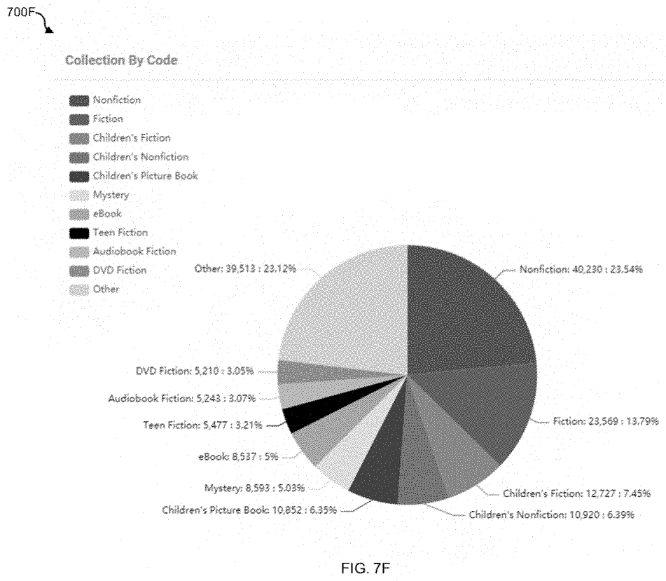

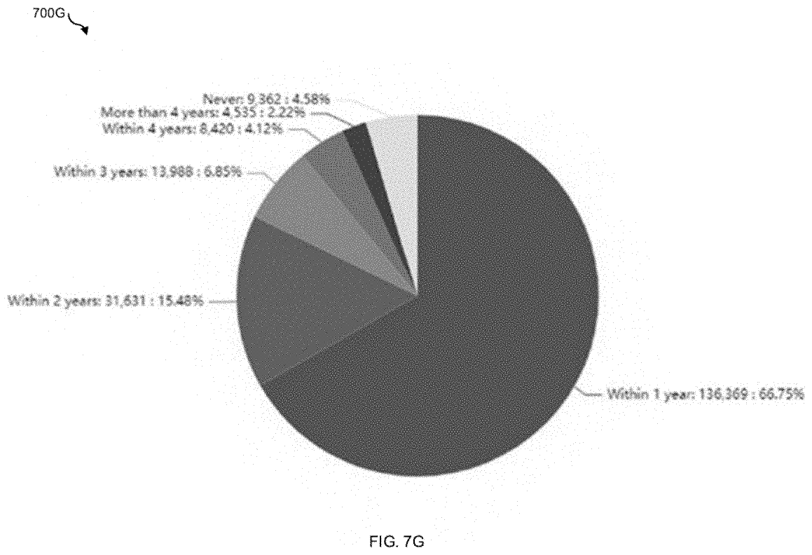

At 402, application server 120 may host and execute an application 123 to generate a graphical user interface (GUI) for receiving a user request corresponding to a report definition. For example, FIG. 7A will be discussed below and shows an example GUI 700A presented on a display of the user computing device 130 for receiving user requests. The user may navigate within user interface elements in the GUI 700A through a browser or mobile application 133 running on a user computing device. The GUI 700A may be configured to allow a user to submit user requests and access to various generated library reports via the user computing device 130. The application 123 may be a dashboard application configured to identify the parameters and or attributes corresponding to the user interface elements selected by the user via the GUI 700A. The application 123 may be configured to present the real time visualized library reports including item data processing results generated by the processor 121 based on the processes 300 and 400.

The report definition may include one or more of item attributes corresponding to user interface elements configured to be selected by a user to initiate a user request for library reports. As illustrated in FIG. 7A, the set of item attributes may include “Age” (e.g., age group), “Classification”, “Material Type”, “Format”, and “Branch Location”. Each item attribute may include a set of features associated to a library item. For example, an attribute of “Classification” may include a set of features or sub-categories of “Fiction”, “Non-Fiction”, and “Other”. An attribute of “Format” may include a set of features of “Print”, “Audio Book”, “Movie,” or “Other” format. The user may select a combination of user interface elements each corresponding to a feature from each item attribute via the example GUI 700A. The user selections of a set of item attributes may correspond to different item categories related to a plurality of library items. A combination of user interface elements may correspond to different item categories associated with related item attributes. Application server 120 may identify a report definition including a combination of selected user interface elements and generate a corresponding library report based on the process 400.

At 404, application server 120 may determine whether a library report is pre-generated for the report definition. When a user requests a report that is not previously accessed, a definition of that report may be created, and the corresponding metadata may be collected and stored with the report definition and added to the decision tree of the machine learning algorithm (e.g., random forests algorithm). When a user request is made for an existing pre-generated library report, the metadata associated with related items of the corresponding item categories may be updated in the decision tree of the machine learning algorithm. For example, the system uses a combination of report metric requested and the specific parameters for the report. This may include a time period, collection code, age group, material type, category, etc. Essentially any parameter that may be called are combined to create a unique report name and parameter hash. If that report name and parameter hash are not contained in the cache, the report is run immediately. If it is in the cache, the data is then returned, and the machine language model updated.

At 406, if application server 120 determines that the library report is pre-generated for a pre-generated report definition, application server 120 may execute a report generation engine 126 to generate a graphical user interface based on the pre-generated report definition and present the pre-generated report with respective calculated metrics corresponding to the user request on the display of the user computing device 130.

At 408, if application server 120 determines that the library report is not pre-generated, application server 120 may collect and store respective metadata of the processed item datasets to generate a new report definition.

At 410, application server 120 may calculate the one or more metrics for the processed item datasets during a selection of a time period based on the new report definition for the user request. The data processing model 124 may be executed to calculate the one or more metrics for the report definition with respect to different collection codes or item categories of the processed item datasets during a selected time period.

At 412, application server 120 may execute the machine learning algorithm on the processed item datasets based on the new report definition to identify a new report corresponding to the user request. The identified new report may most likely to be requested in a defined upcoming period. The report generation engine 126 may be executed by the processor 121 to generate a web-based graphical user interface to present one or more library reports on the display 134 of the user computing device 130.

At 414, application server 120 may execute a report generation engine 126 with the new report definition to present the one or more library reports with the one or more calculated metrics. The one or more calculated metrics may correspond to different collection codes or item categories presented to the user on the display of the user computing device 130.

The process 400 may allow subsequent accesses of those reports to use the pre-generated result sets that contain the most recent report metrics so that the process may be operated to provide the data and reports immediately, thereby eliminating the need to generate or run the reports in real-time. A built-in task scheduler may be run at a periodic time (e.g., hourly, daily, weekly). Application server 120 may iterate through each individual library of the platform. The random forest classifier may generate a list of the top candidates reports or the corresponding report definitions that are most likely to be requested in a defined upcoming period. The scheduler may forward the generated list of the report definitions to the report generation engine which is configured to run those specific report definitions.

The processes 300 and 400 may be executed to dynamically generate and present library on customizable dashboards. For example, the library reports may be presented as a graphical user interface including textual, numeric, and graphical data in a tabular or graphical form. By referring to FIG. 2, the library reports may be generated by executing the report generating engine 126 to perform circulation analysis, and generate and present circulation statistics 212, circulation trend 214, circulation detail 216 and circulation performance 218, etc.

Embodiments of the present disclosure may provide solutions of generating library reports integrated with circulation behavior in real time. In response to user requests, the application server 120 may generate metrics corresponding to collection codes related to item categories and attributes of the processed item datasets. Application server 120 may provide the customizable dashboard integrated with the circulation behaviors and data. Users may navigate in GUIs presenting different customized reports to view circulation and collection analysis results against the greater library field.

An Action Plan Report

A user may access the library management system via accessing the application 123 through a browser or mobile application 133 running on a user computing device 130 via network 110. For example, a user may view the circulation performance report by selecting categories and library branches.

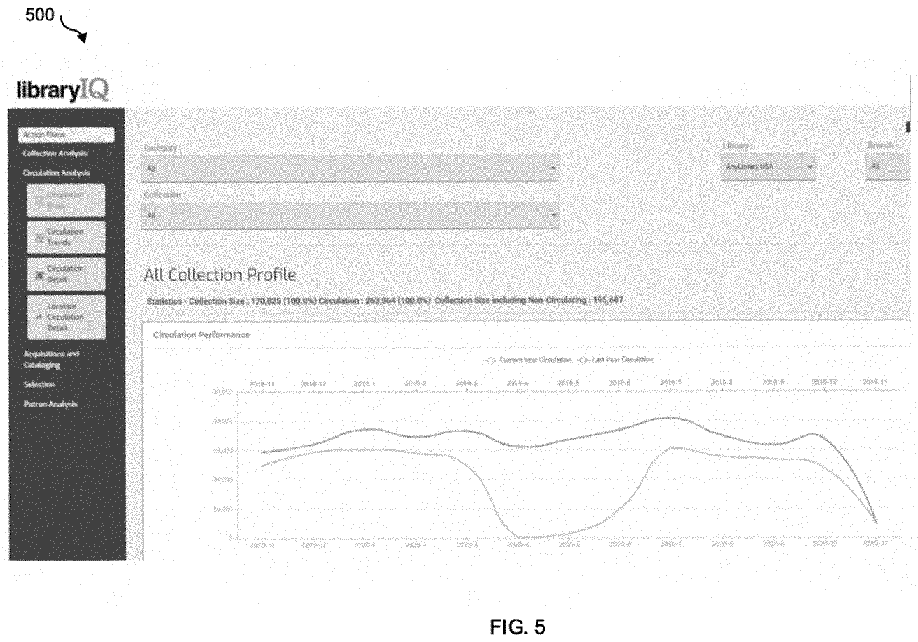

FIG. 5 shows an example GUI of a graph 500 illustrating all collection profile representing system circulation performance. The graph 500 may include selectable user elements associated a set of categories.
1) Children's (Children's Print, Audio, and E-books)
2) The Young Adult (The Young Adult Print, Audio, and E-books)
3) Adult (Adult Print, Audio, and E-books)
4) Movies & Music
5) All Collection Categories

Action plans may help the user to understand how the collection is working before making any decisions. The system with multiple branches may have an “All” page for system performance wide statistics as well as set of categories for each branch location. To view circulation statistics (e.g., by initiating the user interface element of “Circulation Stats” displayed on the GUI 500) or the action plan for collection within a specific category, a user may choose a category displayed on the GUI 500, the collection items and the information may populate in the graph. Action plans may be written for each library system and may be divided into several categories. To view statistics for a specific collection within a category, the user may choose the items and the information may populate in a corresponding graph. For example, a user may review the balance of the collection by age and collection.

As illustrated in FIG. 5, circulation performance shows current year circulation data and last year circulation data. The “Current Year Circulation” is shown as a blue line which may allow the user to quickly view circulation trends of the current year, hover over data point to see an exact circulation for selected month. The “Last Year Circulation” is shown as an orange line which may allow the user quickly compare circulation trends to past year, hover over data point to see an exact circulation for selected month.

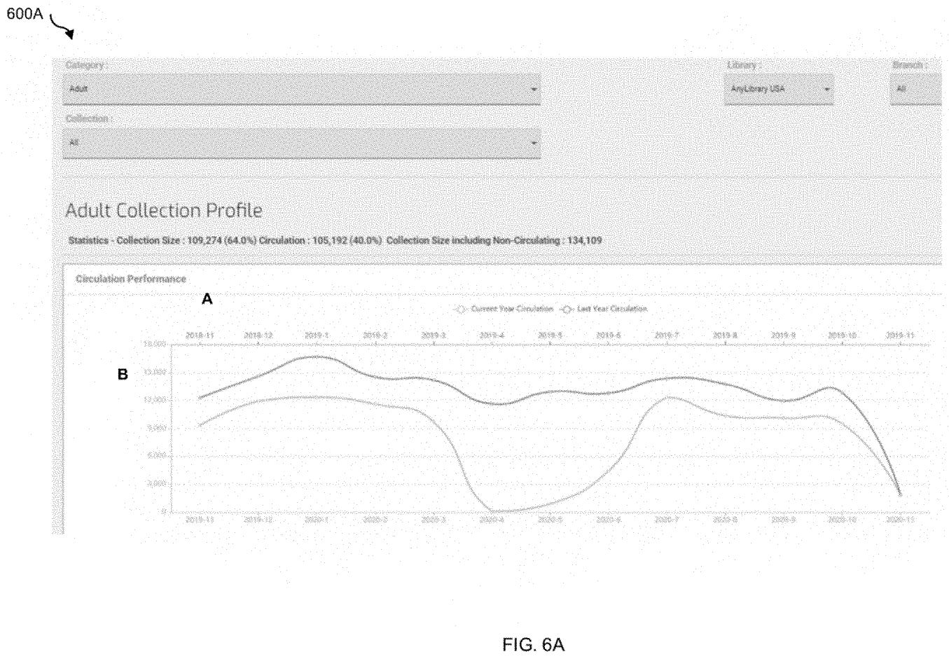

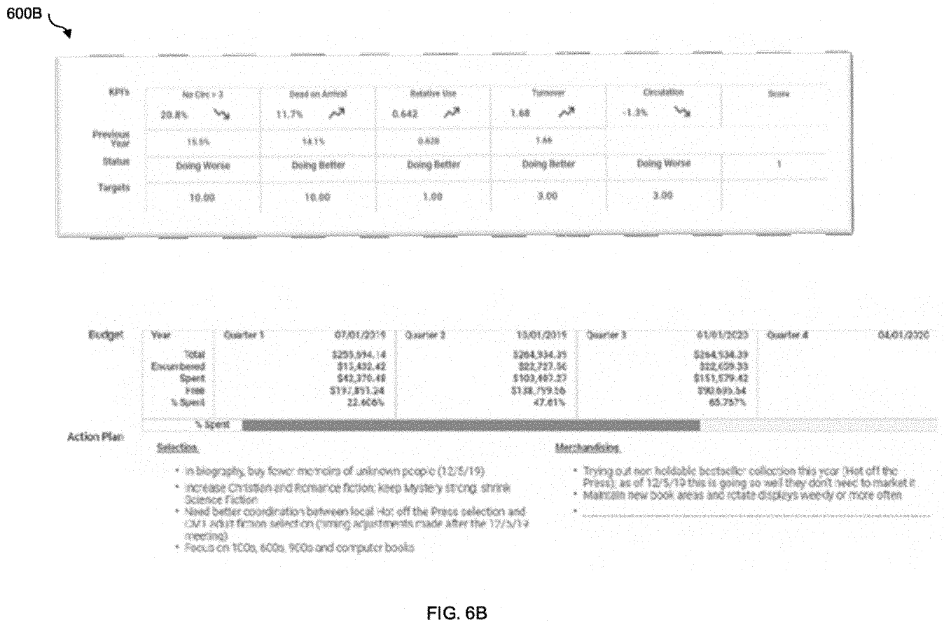

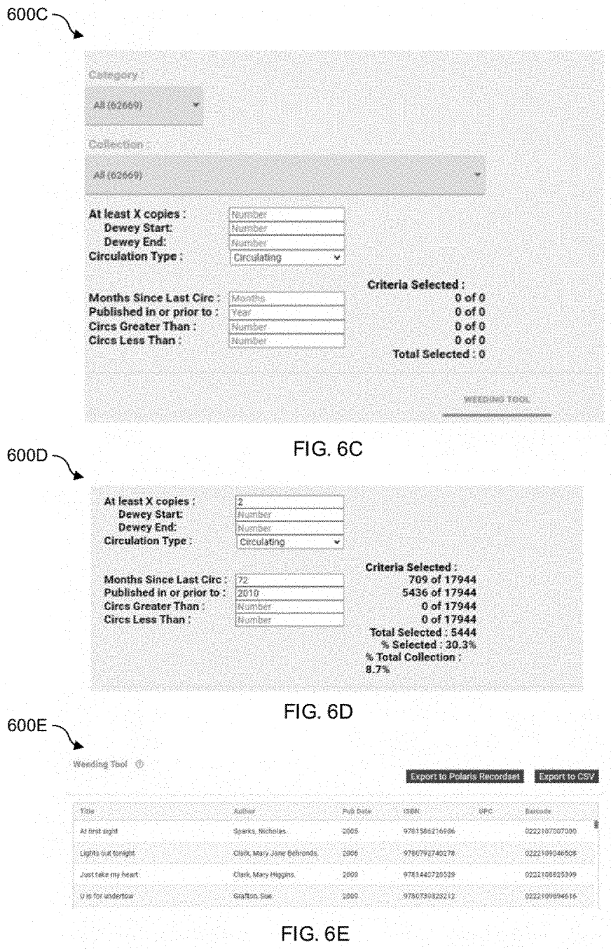

FIG. 6A shows an example GUI of a graph 600A illustrating an adult collection profile based on collection analysis 222 related to a library branch or all branches in the library system. For example, the adult circulation performance in the part A of FIG. 6A may include a collection size, a total number of items in a circulation, a collection size including non-circulating items.
1) Collection Size—This number is updated daily with items added and weekly for items discarded.
2) Circulation—This number represents the past 12 rolling months of circulation.
3) Collection Size including Non-Circulating—This number includes items that do not circulate such as reference materials.

As illustrated in the part B of FIG. 6A, the blue line represents the circulation from the current year, the green line represents last year's circulation. The user may hover over the month data point to see total circulation and collection for the month. The user may continue the analysis by running the data for each branch in the library system and compare the location performance against the system's performance.

FIG. 6B shows a library report including a set of Key Performance Indicators (KPIs) for evaluating the circulation performance and perform collection analysis for each branch based on a library report.

1. Previous Year

The previous year value indicates an exact time 12 months ago.

2. Status/Red and Green Arrows

The status arrows allow the user to quickly see which measures have improved when compared to last year.

3. Score

The score shows one point for measures moving in the positive direction and subtracts one point for measures moving in the negative direction. The 5 KPIs are totaled to get the overall scores.

4. Targets

The user may set targets for an improvement over the coming year.

5. No Circ>3

This measure includes only the items that were added to the collection prior to three years ago that have not circulated in the last three years. It does not include items from non-circulating collections. A magnifying glass will appear when the user hover over the percentage. Clicking on the percentage may take the user directly to a list of items that have not circulated in three years.

6. Dead on Arrival (DOA)

DOA is a key indicator of items that has never circulate.

This measure includes items that were added to the user collection from 15 months ago to 3 months ago that have not circulated. Scores under 10% are considered good, since some libraries estimate 5 to 6% for potential loss through theft, similar to that of a retail bookstore. The higher the score, the more the user may need to adjust the user future purchasing to meet the needs of the user community. A user may use a magnifying glass to hover over the percentage and clicking on the percentage may take the user directly to a list of items that are considered to be “Dead on Arrival”.

7. Relative Use (RU)

This measure compares circulation to the size of the collection. A perfectly balanced collection would have a relative use of 1. A score below 1 may indicate that the branch has more material than it needs and the relevant category/collection needs for weeding. A score above 1 indicates a demand for more materials to meet demand in the category/collection of the branch. The pure Relative Use score does not account for differences in loan periods between types of items. Adjusted Relative Use (RU-Adj) does account for differences in loan periods, and it is found in the Collection Codes view. Check the Relative Use figure for each age and collection. This process may be performed continuously by location and note where the collection needs to be enhanced. Further, the measure or score of the indicator or parameter “Relative Use (RU)” is useful for identifying and managing collection imbalances between branches in the library systems with floating collections.

8. Turnover

This score indicates how many times the average item in this collection circulates in a given year. A score of 3 is considered standard for print collections. DVD collections with shorter loan periods may have much higher scores.

9. Circulation

This score indicates the change in circulation over the last 12 months.

Collections between branches may be compared based on the standard KPIs, such as “Relative Use (RU),” “Turnover,” “DOA” and “No Circ>3 years.”

Collection Analysis 222 using Weeding Model 220

FIGS. 6C-6E show example GUIs representing graphs related to the collection analysis 222 performed by executing the weeding model 220. As illustrated in FIG. 6C, the weeding model 220 executed as a weeding tool in FIG. 6C or a real-time query engine to generate an example GUI 600C which includes data entry fields or selectable user interface elements to represent various criteria based on use inputs or selections. The example data entry fields may include, but are not limited to:
1) “Category” configured to limit analysis results, e.g., by “Age” or “Movies and Music”
2) “Collection” configured to limit analysis results by selecting a specific branch collection.
3) “At least X copies” configured to identify item titles with multiple copies that can be weeding targets. “At least X copies” uses “AND” logic and will limit an overall list of items.
4) “Dewey Start/Dewey End” configured to provide Dewey numbers assigned by the Library of Congress. They are not the unique call numbers from a local library. The data entry fields of “Dewey Start” and “Dewey End” involve “AND” logic. Both data entry fields allow a user to enter appropriate numbers for the weeding model 220 executed to run a report of titles that have not circulated in 24 months and are between 300 and 399, for example.
5) “Circulation Type” configured to be a selectable user interface element which provides selection options, such as “Choose All,” “Circulating” or “Non-Circulating.” The element of “Circulation Type” uses an “AND” logic along with other criteria and can be limit the overall list of items.
6) “Months Since Last Circ” configured to manipulate the collection analysis 222 to any time period for the user to view the updated figures. The weeding model 220 may be executed to generate a search result with an input of a smaller number and return a long list which may take time to populate. A way to frame the search can be done by selecting 72 months at the beginning. “Months Since Last Circ” is configured to use “OR” logic along with other criteria within a search of the collection analysis 222.
7) “Published in or prior to” configured for the user to enter a year to view all titles that were published prior to and within the year the user entered. “Published in or prior” is configured to use “OR” logic along with other criteria within a search of the collection analysis 222.
8) “Circs Greater Than/Less Than” configured to identify titles that have a lifetime circulation higher or lower than a particular number. “Circs Greater Than/Less Than” is configured to use “OR” logic within a search of the collection analysis 222.

FIG. 6D shows an example GUI 600D which illustrates an example collection analysis result based on criteria selected or entered by the user. The display 134 of the user computing device 130 shows the number of items changed and returned under the criteria, as well as the percentage of the selected collection and the entire library collection that may be weeded. As illustrated in FIG. 6D, the search result may include the following parameters and criteria. For example, the search requires 2 copies of the title and the material that circulates 17,944 titles. The collection group is then filtered with the following “OR” logic of the selected criteria:
1) Items have not circulated in 72 months (709 titles), or
2) Items were published in or before 2010 (5,436 titles).

The example GUI 600D illustrates a list which populates the titles and removes any duplicates (e.g., an item that has not circulated in 72 months and was published in or before 2010).

FIG. 6E shows an example GUI 600E which illustrates the collection analysis result with weeding list and downloadable functions. The weeding tool may be used to identify specific titles that can be moved from one branch to another. The example GUI 600E may include selectable user interface elements, but are not limited to:
1) “Export to Polaris Recordset” configured to be selected by a user to initiate the user request to export the selected items as a record set, directly into Polaris ILS. A record set will be created automatically Input the Polaris username and a name of the record set, no need to export or import. Use the record set to bulk change a set of weeded items to be withdrawn or a set of items that were not found in an inventory to missing.
2) “Export to CSV” configured to be selected by a user to export the list as a CSV file for upload to Excel or to the inventory/weeding scanners available from the system 200.

There are many ways for the user to check and develop weeding plans or weeding selections. Besides using the weeding tool, many other areas of the library management system portal may provide useful information on weeding the collection. For example, the “Collection Code,” “Collection by Dewey” and “Collection by BISAC” areas all show the % of the collection with “No Circ>3 Years”. While the user may not use “No Circ>3 Years” as a criterion, those percentages can give the user a rough idea of how much a particular area of the collection may need to be weeded. In another example, useful weeding data may show up in the circulation statistics section and weeding targets may be set in the action plan section.

Circulation Analysis—Circulation Statistics 212

FIGS. 7A-7E show example GUIs representing graphs related to generate circulation statistics of the library reports. As illustrated in FIG. 7A, a user may submit a request to select a set of item attributes corresponding to different item categories of the library items. For example, a user may submit a request by initiating a user interface element of “Statistics Stats” and choosing desired “Age”, “Classification”, “Material Type”, and “Library/Branch” via the example GUI 700A such that application server 120 can identify a combination of selected attribute features as a report definition. Application server 120 may calculate the metrics of the processed item datasets of the items associated with the selected report definition. FIG. 7B shows an example graph 700B presenting a circulation statistics report generated by the processor 121. The graph 700B may be a numerical graph configured to display the collection corresponding the user request. The graph 700B shows a numeric graph with a set of data points each corresponding to a total number of items circulated on the chosen date. The chosen date may correspond to a data point with a movable bar 502 and a text dialog box 504 indicating the related circulation stats. The user may click on the data point to view metadata of the collection of related items on the chosen date.

FIG. 7C shows an example GUI illustrating a graph 700C of metadata of the items in the collection corresponding to FIG. 7B. The user may click the item title to view item details such as an item picture, title, publisher, publication date, page count, introduction, etc.

FIG. 7D shows an example GUI illustrating a graph 700D of daily item hold information associated with the use request described in FIG. 7A. The user may click on the corresponding data point to view metadata of the items that are on hold on the chosen date.

FIG. 7E shows an example GUI illustrating a graph 700E representing circulation by code (item category) in a generated report. The graph 700E represents the highest circulating 10 collection codes. The graph appears when the attributes of “Age”, “Classification” and “Material Type” are set to “All”. Circulation by codes may be updated daily and include the past 12 rolling months of circulation.

FIG. 7F shows an example GUI illustrating a graph 700F representing collections by codes or item categories associated with a generated report. The graph 700F represents the percentage of collection make-up by the top 10 collection codes. This graph is associated with a user request when the “Age”, “Classification” and “Material Type” are set to “All”. The report of “Collection By Code” may be updated daily.

FIG. 7G shows an example GUI representing a graph 700G of “Time since last use” associated with a generated report. The graph 700G shows the percentages of the collection that has been circulated in a given time period. The graph 700G may generated by filtering the items with attributes of a whole system, Branch, Age Group, Classification (fiction, nonfiction, other), or Material Type (print, ebook, movie, audio book, etc.) or any combination of the filters above. Strive for circulation within the last year to be 50% or more, and for “Never” to be as small as possible. The user may use the magnifying glass to check the circulation similarly illustrated FIG. 7C for each segment and view item metadata of the corresponding items.

Circulation Analysis—Circulation Trends 214

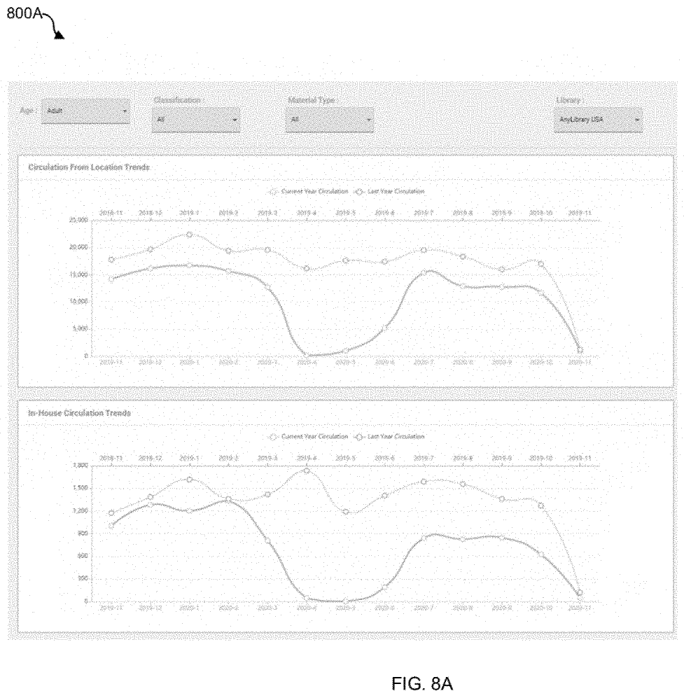

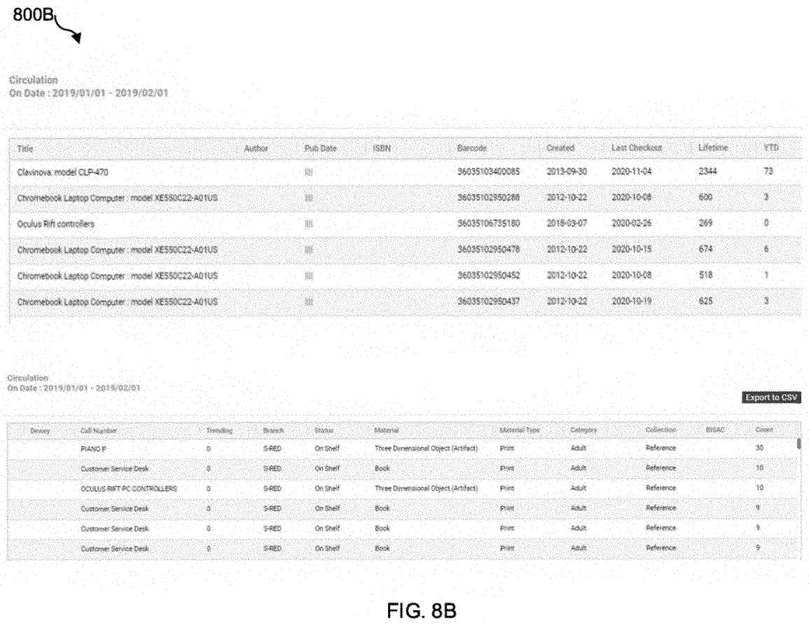

FIG. 8A is an example GUI illustrating a graph 800A of circulation trends in a generated report. Circulation Trends may provide a user with an annual graph of the current year's circulation as well as data on in-house use compared to last year's figures. The Institute of Museum and Library Services does not consider in-house use to be circulation, therefore the corresponding number may not reflect in the majority of the library system. However, it is a valuable number to show patron use (e.g., borrowing activities) of the collection. Data representing with the circulation trends can be presented by Age (Adult, The Young Adult, Children and Other), Classification (Fiction, Nonfiction, and Other) and Material Type (Print, Movie, eBook, Audio Book and Other) or any combination of the above. Data may be displayed for the library, or for each individual branch. As illustrated in FIG. 8A, the blueline represents a circulation trend of the current year, and the brown line represents a circulation trend of the previous year. The user may view the items in the selected monthly circulation by clicking each data point.

FIG. 8B shows an example graph 800B of a monthly circulation record. Each item listed in FIG. 8B may be presented with item metadata in a table including an item title, item metadata, circulation records, circulation stats, etc. Item title detail may be exported as CSV file for further analysis in Excel or other programs. The charts of inhouse circulation details may be exported as PDF documents. The user may view comparisons of annual circulation by navigating to the “Action Plans” page.

Circulation Analysis—Circulation Detail 216

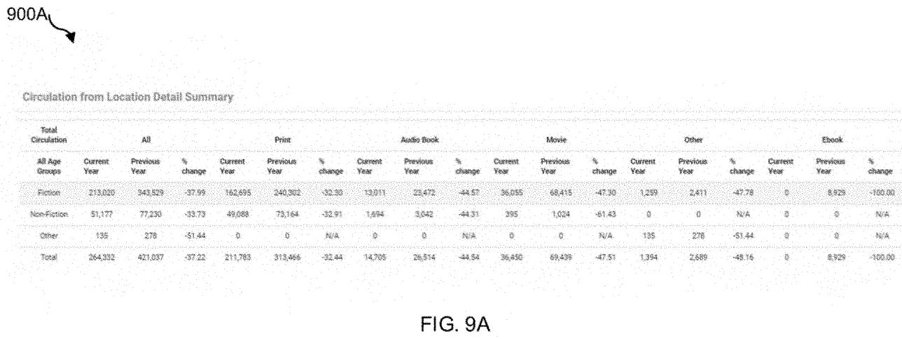

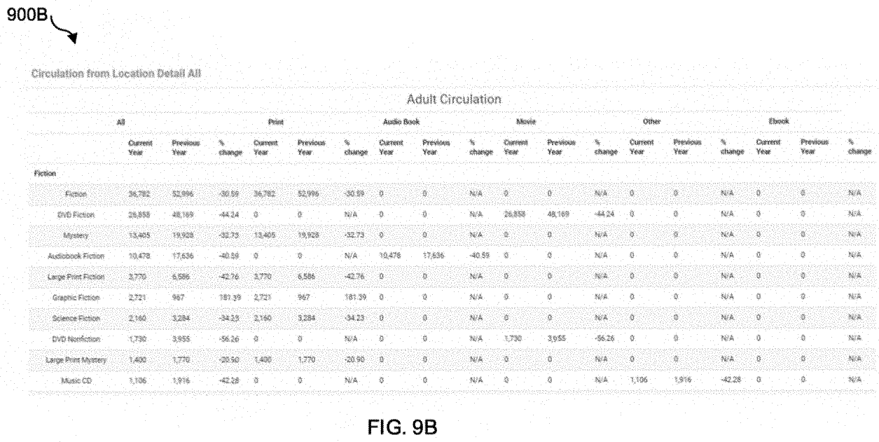

FIGS. 9A-9B are example GUIs illustrating graphs of circulation detail in the generated reports. FIG. 9A shows an example GUI of a graph 900A illustrating circulation detail. The circulation detail may show comparative data (e.g., “% change”) of the circulation between the current year's total circulation and the previous year's circulation with respect to different collection codes and categories. The circulation detail may help the user to identify potential collection problems and quickly identify which areas of the collection may need some attention. Data of the circulation detail may be displayed for all age Groups and may be divided into fiction and nonfiction categories based on different formats such as “print”, “audio book”, “music”, “Ebook”, and others.

FIG. 9B shows an example GUI of a graph 900B illustrating circulation detail in a library report. Circulation data may be presented by an age group according to collection codes or item categories, such as “Fiction” and “Nonfiction” codes. As illustrated in FIG. 7B, collection codes are sorted by the number of items of the circulation from the highest value to the lowest value. A comparative data (e.g., “% change”) between the previous year and the current year may be shown for each collection code according to different item formats. For example, for the “Fiction” code, the graph 900B circulation data shows a 30.59% collection decrease between the previous year and the current year.

Circulation Analysis—Circulation Performance 218

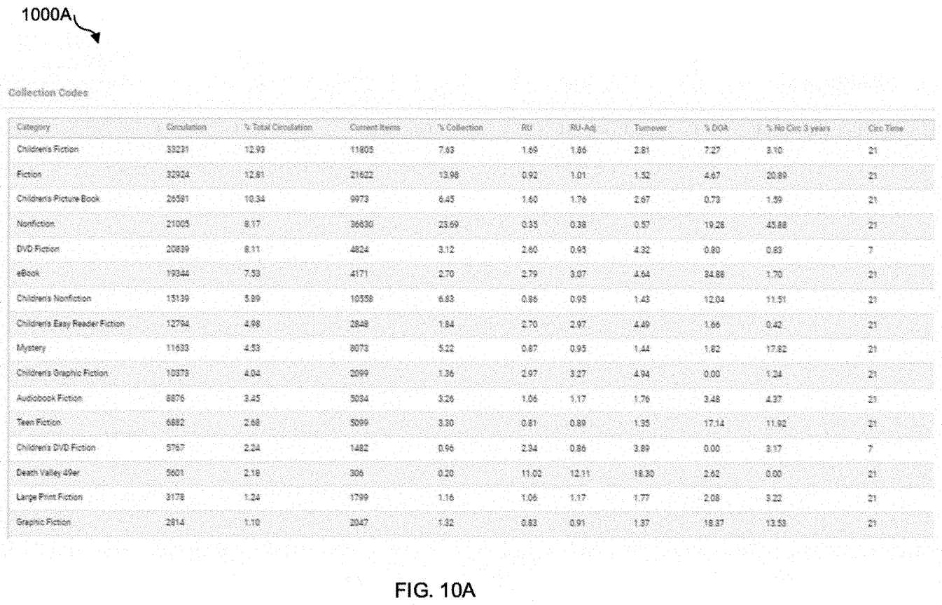

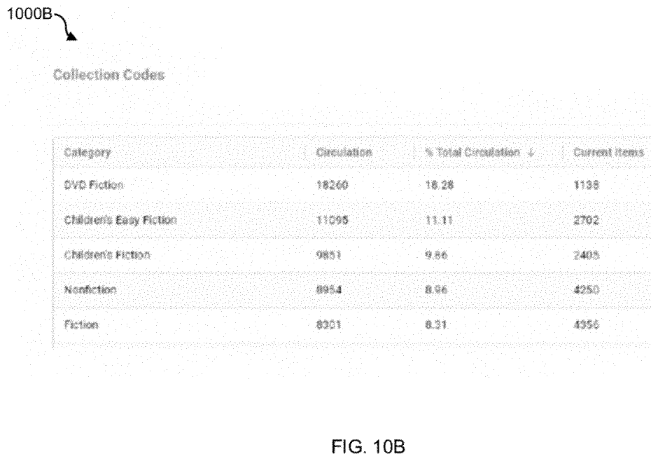

FIGS. 10A-10B shows example GUIs illustrating graphs with collection data related to circulation performance. FIG. 10A shows an example GUI of a graph 1000A illustrating collection data corresponding to different collection codes or item categories in a library report. The user may select all branches or a particular branch to view the corresponding collection data for the circulation performance. The collection data corresponding to different collection codes may provide a user the most robust view of collection data. For each collection code, the use may view the listed metrics associated with respective Key Performance Indicators (KPIs) corresponding a collection code or an item category.
1) “Circulation” indicative of a total circulation for this collection in the past 12 months
2) “% Total Circulation” indicative of a percentage (%) of a total circulation for the corresponding collection in the past 12 months
3) “Current Items” indicative of a total number of items in this collection. The user may use magnifying glass to view list of relevant items.
4) “% Collection” indicative of percentage of total collection
5) “Relative Use (RU)” indicative of a metric that compares the circulation to the size of the collection (relative use)
6) “RU-Adj” indicative of an adjusted relative use to compare the circulation to the size of the collection while adjusting for the variety of loan periods
7) “Turnover” indicative of an average time that each item in a category of this collection circulates in a given year
8) “DOA” indicative of items that were added to the collection from 15 months ago to 3 months ago that have not circulated. The user may use the magnifying glass to view a list of relevant items.
9) “% No Circ 3 Years” indicative of a percentage of collection that was added more than 3 years prior and has not circulated in 3 years. The user may use magnifying glass to view list of relevant items.
10) “Circ Time” indicative of a loan period for each collection.

The user may click on each KPI indicator of the metrics listed in FIG. 10A to sort the values corresponding to the metric and the collection codes.

FIG. 10B shows an example graph 1000B illustrating the collection sorted by the collection codes or categories. FIG. 10B may illustrate one of the most important reports through the library management system portal. For each collection code, it can provide the current number and a percentage of items in the collection, the amount and percentage of circulation in the collection in the past 12 months, as well as the KPIs for the corresponding collection. For example, the user may view the most popular collection corresponding to the category of Children's Picture Book which accounts for 10.7% with an indicator of “% Total Circulation” at the branch. The user may view the list sorted in an ascending or descending order by clicking on the column header or metric indicator.

Collection Report by Decimal Classification

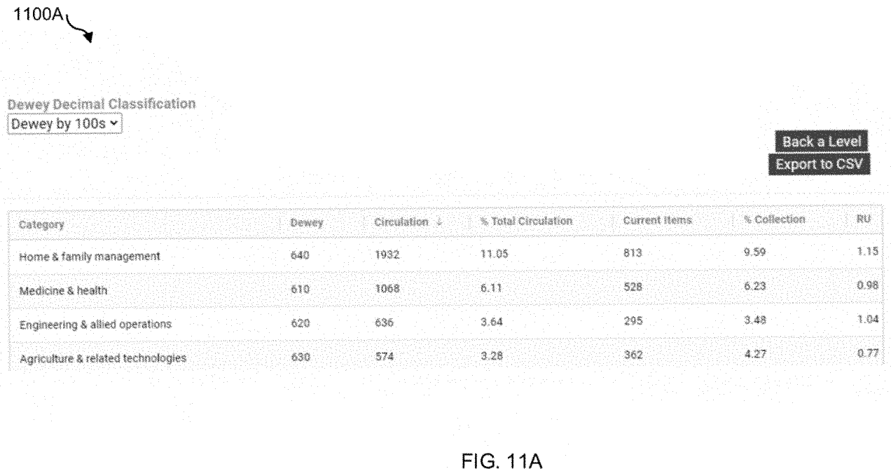

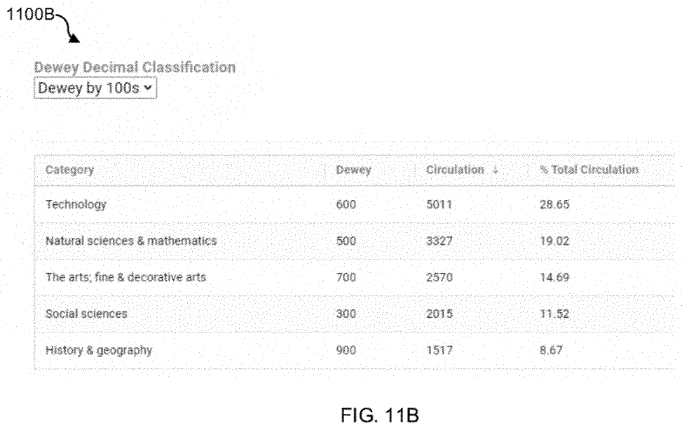

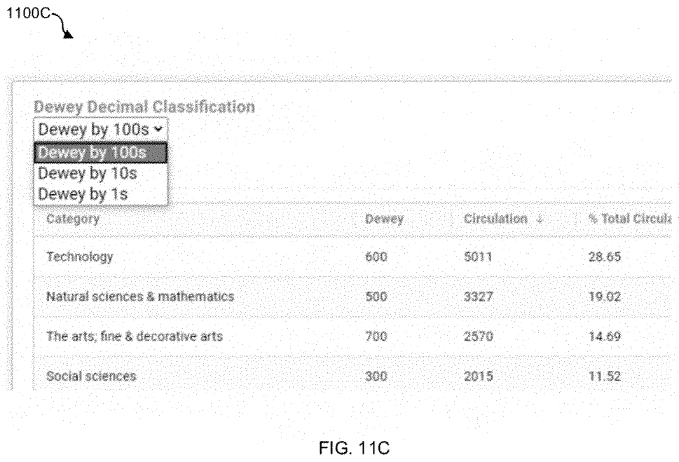

FIGS. 11A-11C shows example GUI with graphs by illustrating selected collections by decimal classification. FIG. 11A shows an example GUI of a graph 1100A illustrating a selected collection by decimal classification which may allow a user to explore the selected collection in greater detail. The report may be generated to display the circulation and collection count broken down by subject area. For example, the user may select a location, choose the appropriate category and collection and view the results. FIG. 11B shows an example GUI of a graph 1100B illustrating metric data of the collection data sorted by any column head or by clicking the metric indicators. The user may download the report data to CSV to sort and filter the data. FIG. 11C shows an example GUI of a graph 1100C illustrating collection data of can be displayed by Dewey decimal classification 100s, 10s, or 1s. For example, the user may click on the listed 100s, 10s or 1s category to display the more specific Dewey decimal classification numbers. The user may click on each category title to view the more detailed breakdown. The user may continue to drill down for specific item titles.

Embodiments of the present disclosure provide various improvements to, and advantages over, existing library information processing technology. The disclosed library management system may effectively provide library item data analysis and customized collection reports in response to user requirements for conducting various collection searches. The advantages of the disclosed principles may include:
1) simplifying collection management and improve collection performance
2) enhancing measurable collection analysis by calculating category metrics corresponding to collection codes during a given time period;
3) improving the overall collection evaluation by utilizing disclosed methods for real-time data importing and processing;
4) generating and presenting measurable library reports in numerical graphs to provide accurate collection performance analysis;
5) providing uninterrupted streamline item data processing and circulation analysis thereby saving time and money while freeing staff and or users to focus on patron service; and
6) increasing the library information processing speed and significantly decreasing library item acquisition and cataloging costs.

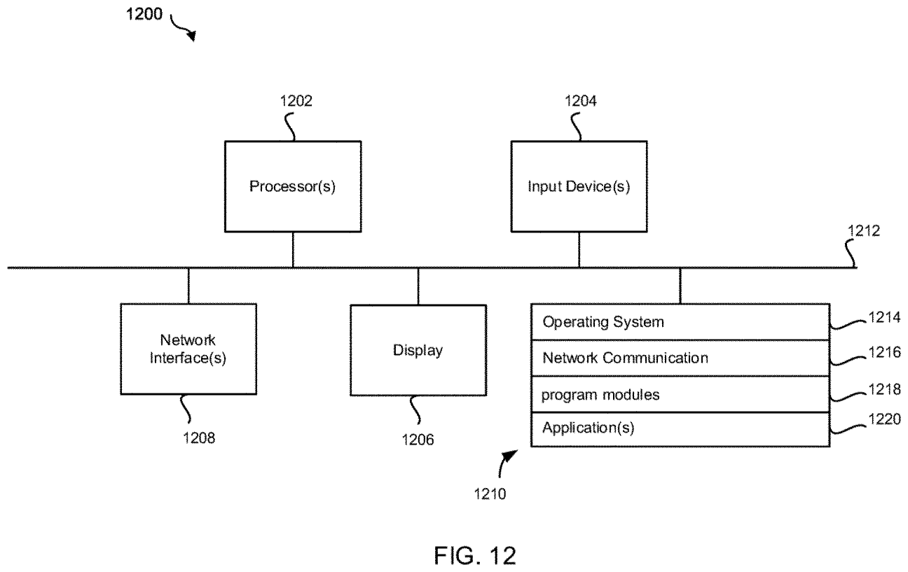

FIG. 12 is a block diagram of an example computing device 1200 that may be utilized to execute embodiments to implement processes including various features and functional operations as described herein. For example, computing device 1200 may function as application server 120, and user computing device 130 or a portion or combination thereof. The computing device 1200 may be implemented on any electronic device to execute software applications derived from program instructions for and as illustrated in FIGS. 3-5, and includes but not limited to personal computers, servers, smartphones, media players, electronic tablets, game consoles, email devices, etc. In some implementations, the computing device 1200 may include one or more processors 1202, one or more input devices 1204, one or more display devices or output devices 1206, one or more communication interfaces 1208, and memory 1210. Each of these components may be coupled by bus 1212, or in the case of distributed computer systems, one or more of these components may be located remotely and accessed via a network.

Processor(s) 1202 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-transitory memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Input devices 1204 may be any known input devices technology, including but not limited to a keyboard (including a virtual keyboard), mouse, track ball, and touch-sensitive pad or display. To provide for interaction with a user, the features and functional operations described in the disclosed embodiments may be implemented on a computer having a display device 1206 such as a CRT (cathode ray tube) or LCD (liquid crystal display) monitor for displaying information to the user and a keyboard and a pointing device such as a mouse or a trackball by which the user can provide input to the computer. Display device 1206 may be any known display technology, including but not limited to display devices using Liquid Crystal Display (LCD) or Light Emitting Diode (LED) technology.

Communication interfaces 1208 may be configured to enable computing device 1200 to communicate with other another computing or network device across a network, such as via a wired connection, a wireless connection, or a combination of wired and wireless connections. For example, communication interfaces 1208 may include an Ethernet interface, an optical interface, a coaxial interface, an infrared interface, a radio frequency (RF) interface, a universal serial bus (USB) interface, a Wi-Fi interface, a cellular network interface, or the like.

Memory 1210 may be any computer-readable medium that participates in providing computer program instructions and data to processor(s) 1202 for execution, including without limitation, non-transitory computer-readable storage media (e.g., optical disks, magnetic disks, flash drives, etc.), or volatile media (e.g., SDRAM, ROM, etc.). Memory 1210 may include various instructions for implementing an operating system 1214 (e.g., Mac OS®, Windows®, Linux). The operating system may be multi-user, multiprocessing, multitasking, multithreading, real-time, and the like. The operating system may perform basic tasks, including but not limited to: recognizing inputs from input devices 1204; sending output to display device 1206; keeping track of files and directories on memory 1210; controlling peripheral devices (e.g., disk drives, printers, etc.) which can be controlled directly or through an I/O controller; and managing traffic on bus 1212. Bus 1212 may be any known internal or external bus technology, including but not limited to ISA, EISA, PCI, PCI Express, USB, Serial ATA or FireWire.

Network communications instructions 1216 may establish and maintain network connections (e.g., software applications for implementing communication protocols, such as TCP/IP, HTTP, Ethernet, telephony, etc.). Application(s) and program modules 1218 may include software application(s) and different functional program modules which are executed by processor(s) 1202 to implement the processes described herein and/or other processes. For example, the program models or modules 1218 may include a data processing model 124, a machine learning model 125, a report generation engine 126 and other program components for accessing and implementing application methods and processes described herein. The program modules 1218 may include but not limited to software programs, machine learning models, objects, components, data structures that are configured to perform tasks or implement the processes described herein. The processes described herein may also be implemented in operating system 1214.

The features and functional operations described in the disclosed embodiments may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

The described features and functional operations described in the disclosed embodiments may be implemented in a computer system, such as a data server, or that includes a middleware component, such as an application server or an Internet server, or that includes a front-end component, such as a user device having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user computing devices and application servers. A user computing device and server may generally be remote from each other and may typically interact through a network. The relationship of user computing devices and application server may arise by virtue of computer programs running on the respective computers and having a client-server relationship to each other.

Communication between various network and computing devices 1200 of a computing system may be facilitated by one or more application programming interfaces (APIs). APIs of system may be proprietary and/or may be examples available to those of ordinary skill in the art such as Amazon® Web Services (AWS) APIs or the like. The API may be implemented as one or more calls in program code that send or receive one or more parameters through a parameter list or other structure based on a call convention defined in an API specification document. One or more features and functional operations described in the disclosed embodiments may be implemented using an API. An API may define one or more parameters that are passed between an application and other software instructions/code (e.g., an operating system, library routine, function) that provides a service, that provides data, or that performs an operation or a computation. A parameter may be a constant, a key, a data structure, an object, an object class, a variable, a data type, a pointer, an array, a list, or another call.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method implemented by a server computing device for dynamically generating library reports, the server computing device comprising a processor and a memory, the memory storing executable instructions that when executed by the processor cause the server computing device to perform processing comprising:
acquiring and receiving a plurality of raw item datasets each associated with a library item from multiple sources;
mapping each of the plurality of raw item datasets to a set of parameters to generate a mapped item dataset for each library item by identifying a unique identifier for each raw item dataset;
processing a plurality of mapped item datasets to output processed item datasets corresponding to one or more metrics; and
dynamically generating one or more library reports by applying a machine learning algorithm on the processed item datasets, wherein the machine learning algorithm is executed to determine a priority of generating each library report based at least on a user request.

2. The method of claim 1, wherein the mapping comprises:
mapping, based on the unique identifier, each raw item dataset to respective metadata of the library item to generate the mapped item dataset through an intermediary table that links the raw item datasets, the respective metadata being indicative of the set of parameters and comprising a publisher, series number, title, author, and a combination thereof.

3. The method of claim 1, wherein the mapping further comprises:
mapping, based on the unique identifier, the set of parameters of the mapped item dataset to a collection code associated with each library item through an intermediary table; and
mapping the collection code to a set of item attributes associated with each respective library item using the intermediary table, wherein the set of the item attributes comprise at least one of an age group, classification, material type, format, and branch location in the intermediary table.

4. The method of claim 3, wherein the collection code comprises one of a total number of circulations, a total number of current items, a percentage of total collection, loan period for each collection, a relative usage at a past given period.

5. The method of claim 1, wherein the processing further comprises:
receiving the user request corresponding to a report definition from a user computing device, the report definition comprising one or more of item attributes corresponding to user interface elements selected by a user;
determining whether a library report is pre-generated for the report definition;
upon determining that the library report is not pre-generated, collecting and storing respective metadata of the processed item datasets to generate a new report definition;
calculating, based on the new report definition corresponding to the user request, the one or more metrics for the processed item datasets during a selected time period;
executing, based on the new report definition, the machine learning algorithm on the processed item datasets to identify a new report corresponding to the user request that is most likely to be requested in a defined upcoming period; and
generating, by a report generation engine and based on the new report definition, a graphical user interface associated with the user request to present the new report with the one or more calculated metrics for the processed item datasets on a display of the user computing device.

6. The method of claim 5, wherein generating the library report further comprises:
upon determining that the library report is pre-generated for a pre-generated report definition, generating, by executing the report generation engine and based on the pre-generated report definition, the graphical user interface to present the pre-generated report with respective calculated metrics corresponding to the user request on the display of the user computing device.

7. The method of claim 5, wherein the library report is generated in response to the user request corresponding to the report definition based on the selected item attributes, the library report comprising circulation statistics, circulation trends, collection by branch, and circulation performance.

8. The method of claim 1, wherein the one or more metrics each are indicative of a relationship to the mapped item datasets, and the one or more metrics may include at least one of circulation metric, patron metric, and collection metric.

9. The method of claim 1, wherein each raw item dataset includes at least one of collection mapping data, circulation data, hold data, and patron data, and each raw dataset is received via a direct application programming interface (API) or FTP file transfer.

10. The method of claim 1, wherein the plurality of the raw item datasets is received from multiple data sources or pulled using a built-in task scheduler at a given time period.

11. A computing system, comprising:
a server computing device in communication with a user computing device via a network, the server computing device comprising a processor and a memory, the memory storing computer-executable instructions which are executed by the processor to:
acquire and receive a plurality of raw item datasets each associated with a library item from multiple sources;
map each of the plurality of raw item datasets to a set of parameters to generate a mapped item dataset for each library item by identifying a unique identifier for each raw item dataset;
process a plurality of mapped item datasets to output processed item datasets corresponding to one or more metrics; and
dynamically generate one or more library reports by applying a machine learning algorithm on the processed item datasets, wherein the machine learning algorithm is executed to determine a priority of generating each library report based at least on a user request.

12. The computing system of claim 11, wherein the instructions are further executed by the processor to:
map, based on the unique identifier, each raw item dataset to respective metadata of the library item to generate the mapped item dataset through an intermediary table that links the raw item dataset, the respective metadata being indicative of the set of parameters and comprising a publisher, series number, title, author, and a combination thereof.

13. The computing system of claim 11, wherein the instructions are further executed by the processor to:
map, based on the unique identifier, the set of parameters of the mapped item dataset to a collection code associated with each library item through an intermediary table; and
map the collection code to a set of item attributes associated with each respective library item using the intermediary table, wherein the set of the item attributes comprise at least one of an age group, classification, material type, format, and branch location in the intermediary table.

14. The computing system of claim 13, wherein the collection code comprises one of a total number of circulations, a total number of current items, a percentage of total collection, loan period for each collection, a relative usage at a past given period.

15. The computing system of claim 11, wherein the instructions are further executed by the processor to:
receive the user request corresponding to a report definition from the user computing device, the report definition comprising one or more of item attributes corresponding to user interface elements selected by a user to initiate the user request;
determine whether a library report is pre-generated for the report definition;
upon determining that the library report is not pre-generated, collect and store respective metadata of the processed item datasets to generate a new report definition;
calculate, based on the new report definition for the user request, the one or more metrics for the processed item datasets during a selected time period;
execute, based on the new report definition, the machine learning algorithm on the processed item datasets to identify a new report corresponding to the user request that is most likely to be requested in a defined upcoming period; and
generate, by a report generation engine and based on the new report definition, a graphical user interface associated with the user request to present the new report with the one or more calculated metrics for the processed item datasets on a display of the user computing device.

16. The computing system of claim 15, wherein the instructions are further executed by the processor to:
upon determining that the library report is pre-generated for a pre-generated report definition, generate, by executing the report generation engine and based on the pre-generated report definition, the graphical user interface to present the pre-generated report with respective calculated metrics corresponding to the user request on the display of the user computing device.

17. The computing system of claim 15, wherein the library report is generated in response to the user request corresponding to the report definition based on the selected item attributes, the library report comprising circulation statistics, circulation trends, collection by branch, and circulation performance.

18. The computing system of claim 11, wherein the one or more metrics each are indicative of a relationship to the mapped item datasets, and the one or more metrics may include at least one of circulation metric, patron metric, and collection metric.

19. The computing system of claim 11, wherein each raw item dataset includes at least one of collection mapping data, circulation data, hold data, and patron data, and each raw dataset is received via a direct application programming interface (API) or FTP file transfer.

20. The computing system of claim 11, wherein the plurality of the raw item datasets is received from multiple data sources or pulled using a built-in task scheduler at a given time period.
